(19) United States
(12) Patent Application Publication
(10) Pub. No.: US 2024/0342940 A1
(43) Pub. Date: Oct. 17, 2024

(54) CUTTING ROLLER AND PAPER DISTRIBUTOR

(71) Applicant: FANER AROMA PRODUCT CO., LTD., Guangzhou, Guangdong (CN)

(72) Inventors: Hsu-hui CHANG, Guangzhou, Guangdong (CN); Yuanshou MO, Guangzhou, Guangdong (CN); Yingyao LIU, Guangzhou, Guangdong (CN); Songwen YE, Guangzhou, Guangdong (CN)

(21) Appl. No.: 18/035,716

(22) PCT Filed: Apr. 26, 2022
(86) PCT No.: PCT/CN2022/089185

§ 371 Date: May 5, 2023

(51) Int. Cl. B26D 1/06; B26D 7/02; B26D 7/26; B26D 7/32

(52) U.S. Cl. CPC B26D 1/065; B26D 7/025; B26D 7/2614; B26D 7/32; B26D 2007/322

(57) ABSTRACT

A cutting roller includes a cutting roller body and a cutting knife assembly, and a knife groove is concavely formed in a peripheral wall of the cutting roller body. The cutting knife assembly includes a knife frame and a paper pushing frame arranged in the knife groove, and a blade mounted on the knife frame. The paper pushing frame is provided with a paper pushing groove matched and sleeved with the blade in a transmission mode, the paper pushing frame is slidably arranged relative to the cutting roller body in a circumferential direction of the cutting roller body. At least one of two ends of the knife frame extending along the knife groove is provided with a linkage component with a swing connecting portion and a driven connecting portion, and the swing connecting portion is rotatably connected with an end face of the cutting roller body.

### CROSS-REFERENCE TO RELATED APPLICATIONS

This application is a national stage filing under 35 U.S.C. § 371 of international application number PCT/CN2022/089185, filed Apr. 26, 2022, the contents of which are incorporated herein by reference in its entirety.

### TECHNICAL FIELD

The disclosure relates to the technical field of paper cutting, and particularly to a cutting roller and a paper distributor.

### BACKGROUND

Paper distributor may automatically cut a tissue pulled out, and generally cut paper by a paper cutting roller, wherein a peripheral wall of an existing paper cutting roller is provided with a knife groove, and a blade capable of extending in and out along with the rotation of the paper cutting roller is arranged in the knife groove. At present, in this paper cutting technology, when the blade cuts the paper, due to inertia or electrostatic adsorption, the paper is hooked at a blade tip or absorbed on the blade, and the paper is brought into the knife groove when the blade is retracted, thus causing paper jam and paper rolling.

### SUMMARY

The disclosure aims to provide a cutting roller and a paper distributor to solve one or more technical problems in the existing technology, and at least provide a beneficial selection or creation condition.

A technical solution used to solve the above technical problems is as follows.

Firstly, the disclosure provides a cutting roller, which comprises: a cutting roller body and a cutting knife assembly, wherein a knife groove is concavely formed in a peripheral wall of the cutting roller body which extends across the cutting roller body in an axial direction; and the cutting knife assembly comprises a knife frame and a paper pushing frame arranged in the knife groove, and a blade mounted on the knife frame, wherein the blade extends along the knife groove, the paper pushing frame is provided with a paper pushing groove, and the blade is slidably matched and sleeved with the paper pushing groove in a transmission mode:

the paper pushing frame is slidably connected with the knife groove, the paper pushing frame is slidably arranged relative to the cutting roller body in a circumferential direction of the cutting roller body, at least one of two ends of the knife frame extending along the knife groove is provided with a linkage component, the linkage component is provided with a swing connecting portion arranged on an inner side and a driven connecting portion arranged on an outer side, the swing connecting portion is rotatably connected with an end face of the cutting roller body, the knife frame is configured to swing back and forth to drive the blade to extend out of and into the knife groove, and the paper pushing frame is configured to follow the blade to move back and forth: when the blade extends out of the knife groove, the paper pushing frame follows the blade to move, and the blade extends out of the knife groove from the paper pushing groove; and when the blade extends into the knife groove, the paper pushing frame follows the blade to move, and the blade extends into the knife groove from the paper pushing groove.

The cutting roller has the beneficial effects as follows. During the rotation of the cutting roller, the knife frame is driven to swing back and forth by the driven connecting portion, so that the blade extends out of the knife groove to cut paper. Under the condition that the blade is slidably matched and sleeved with the paper pushing groove in a transmission mode, when the blade extends out of the knife groove, the paper pushing frame follows the blade to move, and the blade extends out of the knife groove from the paper pushing groove, that is to say, the paper pushing frame will follow the blade to move in a direction in which the blade extends out, and the blade extends out of the paper pushing groove to cut the paper. Subsequently: when the blade extends into the knife groove, the paper pushing frame also follows the blade to move in a direction in which the blade extends in, and the blade extends into the knife groove from the paper pushing groove finally, and the paper pushing frame can push the paper attached to the blade to fall off, so as to effectively push the paper out of the knife groove, thus avoiding paper jam and paper rolling.

In other solutions, in order to improve the swinging stability of the knife frame, two ends of the knife frame extending along the knife groove are both provided with the linkage component.

As a further improvement of the above technical solution, sliding guide frames are fixedly arranged on two end sides of an opening of the knife groove, the sliding guide frame is provided with an arc-shaped guide groove, and two ends of the paper pushing frame are slidably connected with the arc-shaped guide grooves.

In this solution, the paper pushing frame is mounted and guided by the sliding guide frame, wherein the paper pushing frame can move back and forth in an arc-shape along the arc-shaped guide groove, so as to improve the moving stability of the paper pushing frame.

As a further improvement of the above technical solution, two sides of the blade are divided into a paper feeding side and a paper discharging side, and the paper pushing groove is provided with a paper pushing edge closely attached to the paper discharging side.

The paper is generally adsorbed on the paper discharging side of the blade, and by close attachment of the paper pushing groove to the paper discharging side through the paper pushing edge, the paper can be pushed out from the blade, thus reducing the material used for the paper pushing frame.

As a further improvement of the above technical solution, a plurality of rubber sleeves are sleeved on a periphery of the cutting roller body, and the plurality of rubber sleeves are arranged on the cutting roller body at intervals in an axial direction.

The cutting roller body pulls the paper for conveying by a friction, and the rubber sleeve can improve the friction with the paper, thus avoiding slipping.

In addition, the disclosure further provides a paper distributor, which comprises the cutting roller above, and a machine shell, wherein the machine shell is provided with two side plate bases arranged oppositely, two ends of the cutting roller body are rotatably connected with the two side plate bases respectively, an inner side face of at least one of the two side plate bases is provided with a cam groove, and the driven connecting portion is slidably connected and matched with the cam groove.

During the rotation of the cutting roller body, in this solution, the cam groove is slidably connected and matched with the driven connecting portion to drive the knife frame to swing relative to the cutting roller body, which is more compact in structure and easier to realize.

As a further improvement of the above technical solution, the paper distributor further comprises a plurality of paper pressing shaft assemblies and a roll paper mounting and placing assembly mounted on the machine shell, the plurality of paper pressing shaft assemblies are annularly arranged on a peripheral side of the cutting roller body at intervals, the roll paper mounting and placing assembly comprises two sleeving columns, and the two sleeving columns are oppositely arranged on the two side plate bases.

The roll paper mounting and placing assembly is mainly used for placing roll paper, two ends of the roll paper are mounted on the two sleeving columns, a paper head of the paper is wound around the plurality of paper pressing shaft assemblies in sequence, the paper pressing shaft assemblies press the paper on the peripheral wall of the cutting roller body, and the paper is driven to be conveyed forward by a rotating friction. The paper pressing shaft assembly has many structural forms, such as the structure including a smooth shaft and a shaft sleeve sleeved on the smooth shaft, or the structure including a plurality of shaft collars, which plays a role of pressing and guiding the paper.

As a further improvement of the above technical solution, the paper distributor further comprises a roll paper residual amount monitoring assembly, the roll paper residual amount monitoring assembly comprises a monitoring swing frame and a monitoring module, one end of the monitoring swing frame is rotatably connected with an inner side wall of one of the side plate bases, the other end of the monitoring swing frame is connected with a contact pressure block, an elastic reset member is arranged between the monitoring swing frame and the side plate base, the elastic reset member is used for swinging the monitoring swing frame until the contact pressure block approaches a peripheral wall of the sleeving column, and one end of the monitoring swing frame connected with the side plate base is connected with the monitoring module through a transmission rod member.

In this solution, the roll paper residual amount monitoring assembly is further provided to detect a usage amount of the roll paper. Specifically, the roll paper is sleeved between two sleeving columns, under an action of the elastic reset member, the monitoring swing frame drives the contact pressure block to press on a periphery of the roll paper, and an outer diameter of the roll paper is gradually reduced. When a residual usage amount of the roll paper reaches a set value, the elastic reset member drives the monitoring swing frame to swing, and the monitoring swing frame drives the transmission rod member to move. At the moment, the transmission rod member moves relative to the monitoring module, and the monitoring module will send out a warning signal to warn that the roll paper is used up or needs to be replaced soon. The transmission rod member may have various structures. Specifically, the transmission rod member may have a lever structure, a middle portion of the transmission rod member is rotatably connected with the side plate base, one end of the transmission rod member is connected with the monitoring swing frame, and the other end of the transmission rod member abuts against the monitoring module. When the monitoring swing frame swings, the other end of the transmission rod member presses the monitoring module. The monitoring module may be provided with a push switch, and the monitoring module may be provided with a speaker or a warning light to achieve a warning effect.

As a further improvement of the above technical solution, the paper distributor further comprises a rotary driving assembly mounted on one of the side plate bases, the rotary driving assembly comprises a rotary driving unit, a gear transmission mechanism and a first gear coaxially connected with the cutting roller body, and the rotary driving unit is engaged with the first gear through the gear transmission mechanism in a transmission mode.

In this solution, the rotary driving unit drives the gear transmission mechanism to move, and the gear transmission mechanism drives the first gear to rotate, so as to realize the automatic rotation of the cutting roller body.

As a further improvement of the above technical solution, the paper distributor further comprises a manual driving assembly mounted on one of the side plate bases, the manual driving assembly comprises a swing rod member rotatably mounted on the side plate base and a first tension spring connected between the side plate base and the swing rod member, one end of the swing rod member is connected with a sector gear, the sector gear is engaged with the first gear, and the first gear is connected with the cutting roller body through a one-way bearing.

In this solution, the manual driving assembly is further provided, which can drive the sector gear to rotate by swinging the swing rod member, and drive the cutting roller body to rotate under the engagement of the sector gear with the first gear, and the first tension spring may pull the swing rod member to reset. The first gear is connected with the cutting roller body through the one-way bearing, so the sector gear will not drive the cutting roller body to rotate when rotating back to reset.

As a further improvement of the above technical solution, the paper distributor further comprises a reset locking assembly, the reset locking assembly comprises a ratchet wheel coaxially connected with the cutting roller body, a brake block and a second tension spring mounted on one of the side plate bases, the second tension spring is connected between the side plate base and the ratchet wheel, and the brake block is engaged with the ratchet wheel in an elastic stopping mode.

In the solution, the reset locking assembly is further provided to lock and position the cutting roller body and prevent the cutting roller body from rotating in an opposite direction. During the rotation of the cutting roller body, the ratchet wheel pushes the brake block away, arrangement positions of the brake block and the ratchet wheel are also determined according to a rotation direction of the cutting roller body during paper cutting. After the cutting roller body stops cutting paper and rotating, the second tension spring pulls the ratchet wheel, and at the moment, the brake block is engaged with the ratchet wheel in a stopping mode.

### BRIEF DESCRIPTION OF THE DRAWINGS

The disclosure is further described hereinafter with reference to the drawings and embodiments:

FIG. 1 is a schematic structural diagram a paper distributor according to an embodiment of the disclosure;

FIG. 2 is a schematic diagram of an internal structure of the paper distributor according to an embodiment of the disclosure from a perspective, wherein a monitoring module is disassembled:

FIG. 3 is a schematic diagram of the internal structure of the paper distributor according to an embodiment of the disclosure from another perspective:

FIG. 4 is a schematic diagram of an internal transmission structure of one side of the paper distributor according to an embodiment of the disclosure, wherein the monitoring module is disassembled:

FIG. 5 is a schematic structural diagram of a cutting roller according to an embodiment of the disclosure:

FIG. 6 is an exploded view of the cutting roller according to an embodiment of the disclosure; and

FIG. 7 is a schematic structural diagram of an inner side face of a side plate base according to an embodiment of the disclosure.

### DETAILED DESCRIPTION

Specific embodiments of the disclosure will be described in detail in this part, preferred embodiments of the disclosure are shown in the drawings, and the drawings are intended to supplement the description in the written part of the specification with figures, so that people can intuitively and vividly understand each technical feature and the overall technical solution of the disclosure, but it cannot be understood as a limitation to the scope of protection of the disclosure.

In the description of the disclosure, it should be understood that, the orientation or position relationship related to the orientation description, such as the orientation or position relationship indicated by the terms “upper”, “lower”, “front”, “rear”, “left”, “right”, and the like is based on the orientation or position relationship shown in the drawings, which is only used for convenience of the description of the disclosure and simplification of the description instead of indicating or implying that the indicated device or element must have a specific orientation, and be constructed and operated in a specific orientation, and thus should not be understood as a limitation to the disclosure.

In the description of the disclosure, the term “several” if any refers to being one or more, the term “multiple” refers to being two or more, and the terms “greater than”, “less than”, “more than”, and the like are understood as not including the following number, while the terms “above”, “below”, “within”, and the like are understood as including this number.

In the description of the disclosure, unless otherwise explicitly defined, the terms “setting”, “mounting” and “connecting” should be understood in a broad sense, and those of ordinary skills in the art can reasonably determine the specific meanings of the above terms in the disclosure in combination with the specific contents of the technical solution.

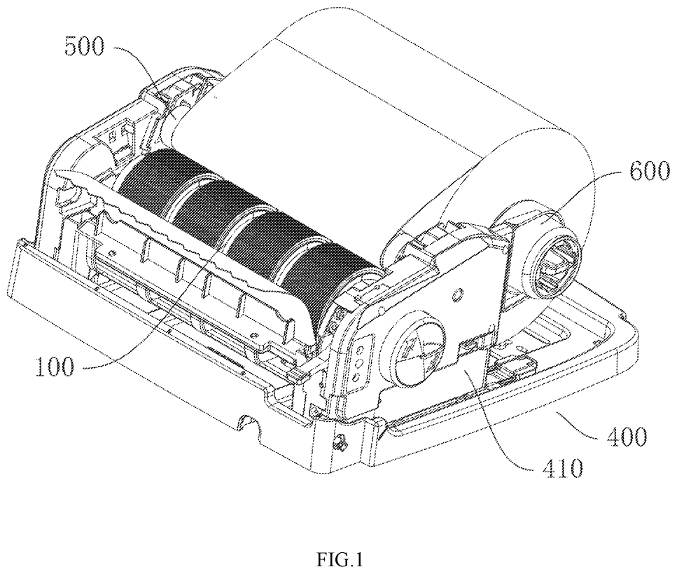

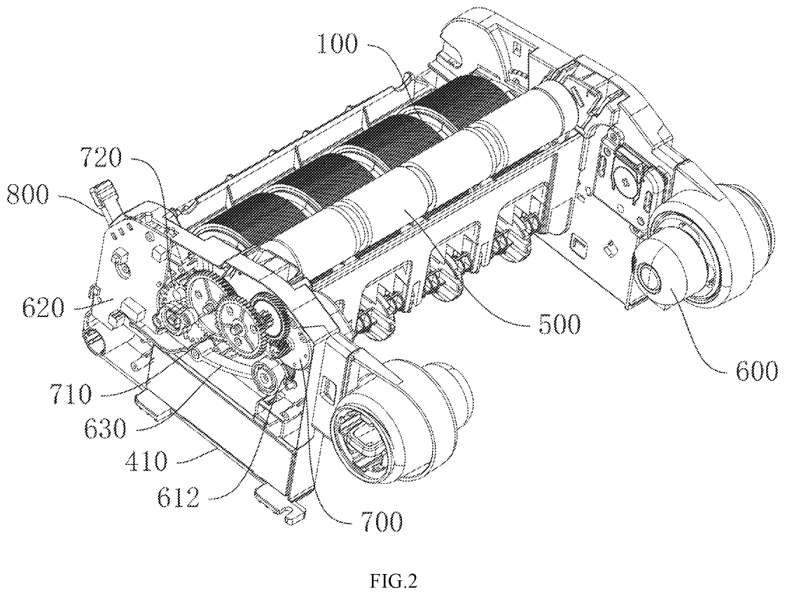

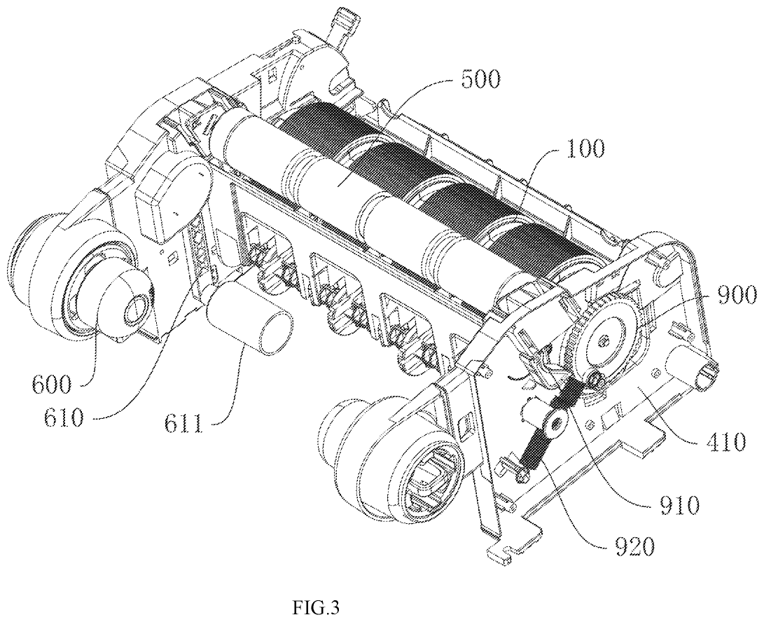

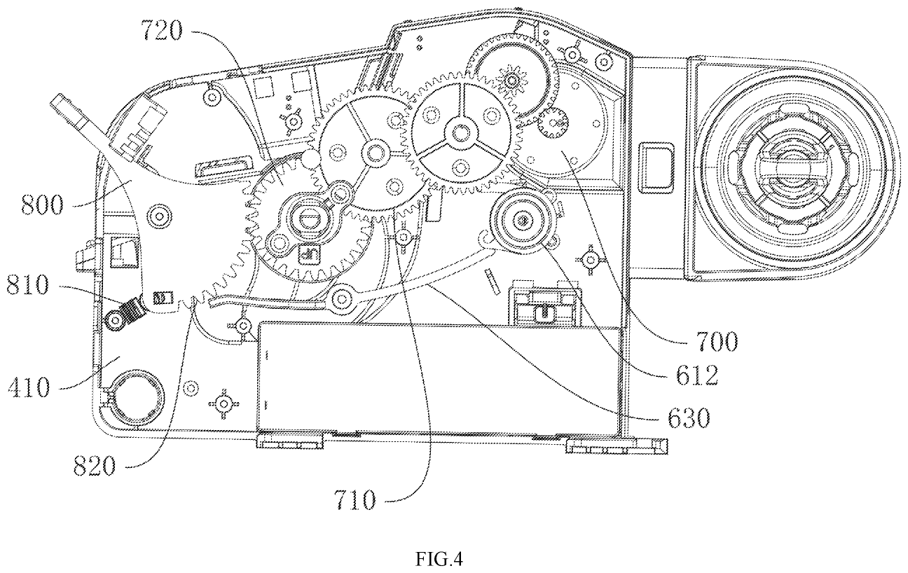

With reference to FIG. 1 to FIG. 7, the following embodiments are made for a paper distributor of the disclosure.

In an embodiment, a paper distributor comprises a cutting roller and a machine shell 400.

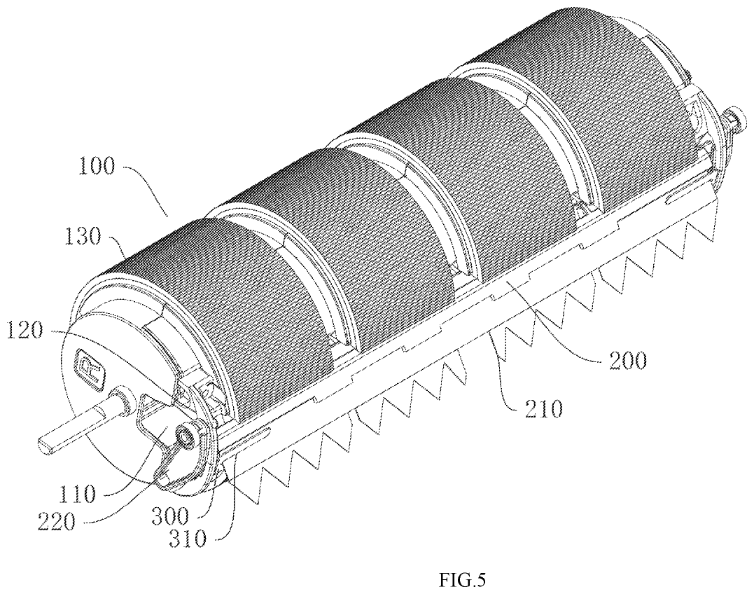

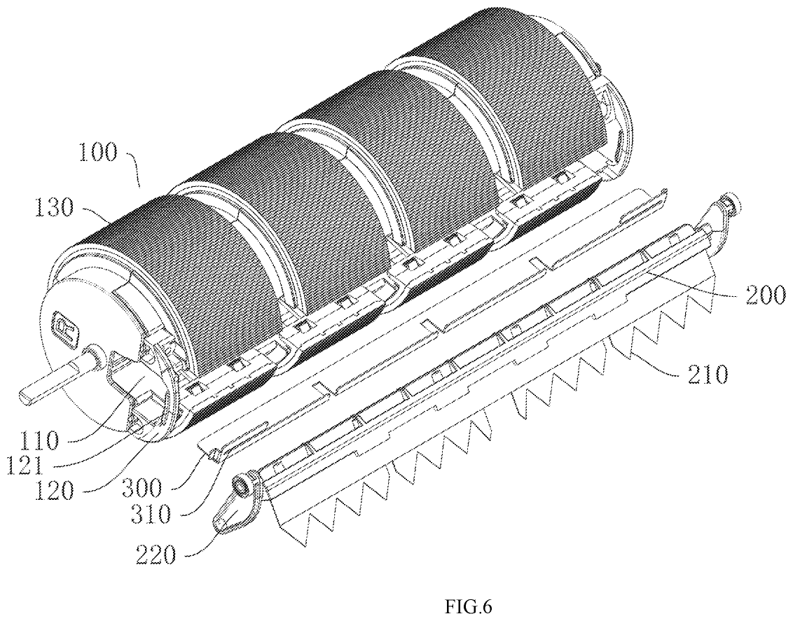

As shown in FIG. 5 to FIG. 6, the cutting roller comprises a cutting roller body 100 and a cutting knife assembly. A knife groove 110 is concavely formed in a peripheral wall of the cutting roller body 100 which extends across the cutting roller body 100 in an axial direction. The cutting knife assembly comprises a knife frame 200 and a paper pushing frame 300 arranged in the knife groove 110, and a blade 210 mounted on the knife frame 200. The blade 210 extends along the knife groove 110, the paper pushing frame 300 is provided with a paper pushing groove 310, and the blade 210 is slidably matched and sleeved with the paper pushing groove 310 in a transmission mode. The paper pushing frame 300 is slidably connected with the knife groove 110, and the paper pushing frame 300 is slidably arranged relative to the cutting roller body 100 in a circumferential direction of the cutting roller body 100. Specifically, sliding guide frames 120 are fixedly arranged on two end sides of an opening of the knife groove 110, the sliding guide frame 120 is provided with an arc-shaped guide groove 121, and two ends of the paper pushing frame 300 are slidably connected with the arc-shaped guide grooves 121. An arc center of the arc-shaped guide groove 121 is an axis of the cutting roller body 100, the paper pushing frame 300 is mounted and guided by the sliding guide frame 120, and the paper pushing frame 300 can move back and forth in an arc-shape along the arc-shaped guide groove 121, so as to improve the moving stability of the paper pushing frame 300.

In this embodiment, two ends of the knife frame 200 along the knife groove 110 are both provided with a linkage component 220, which can improve the swinging stability of the knife frame 200, the linkage component 220 is provided with a swing connecting portion arranged on an inner side and a driven connecting portion arranged on an outer side, and the swing connecting portion is rotatably connected with an end face of the cutting roller body 100.

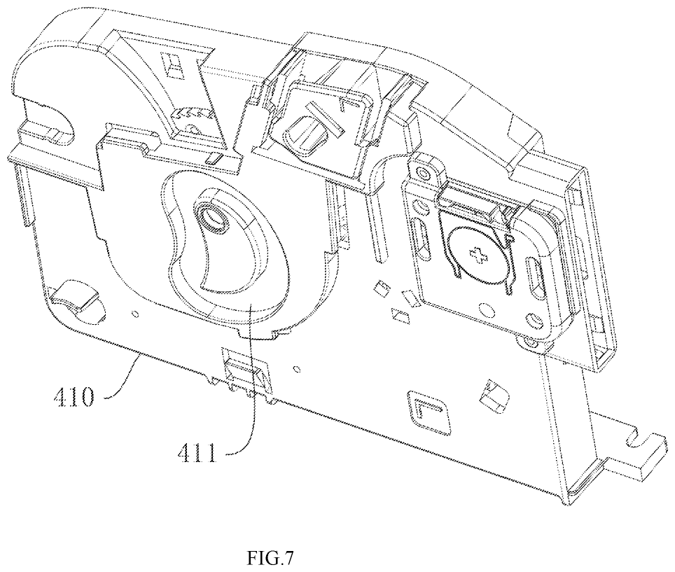

As shown in FIG. 1 to FIG. 4, the machine shell 400 is provided with two side plate bases 410 arranged oppositely, and two ends of the cutting roller body 100 are rotatably connected with the two side plate bases 410 respectively. As shown in FIG. 7, inner side faces of the two side plate bases 410 are both provided with a cam groove 411, and the driven connecting portion is slidably connected and matched with the cam groove 411.

During the rotation of the cutting roller body 100, the cam groove 411 is slidably connected and matched with the driven connecting portion to drive the knife frame 200 to swing relative to the cutting roller body 100, the knife frame 200 swings back and forth to drive the blade 210 to extend out of and into the knife groove 110, and under the condition that the blade 210 is slidably matched and sleeved with the paper pushing groove 310 in a transmission mode, the paper pushing frame 300 follows the blade 210 to move back and forth.

Specifically, when the blade 210 extends out of the knife groove 110, the paper pushing frame 300 follows the blade 210 to move, and the blade 210 extends out of the knife groove 110 from the paper pushing groove 310, that is to say, the paper pushing frame 300 will follow the blade 210 to move in a direction in which the blade 210 extends out, and the blade 210 extends out of the paper pushing groove 310 to cut the paper. Subsequently, when the blade 210 extends into the knife groove 110, the paper pushing frame 300 also follows the blade 210 to move in a direction in which the blade 210 extends in, and the blade 210 extends into the knife groove 110 from the paper pushing groove 310 finally, and the paper pushing frame 300 can push the paper attached to the blade 210 to fall off, so as to effectively push the paper out of the knife groove 110, thus avoiding paper jam and paper rolling.

Two sides of the blade 210 are divided into a paper feeding side and a paper discharging side, and the paper pushing groove 310 is provided with a paper pushing edge closely attached to the paper discharging side. The paper is generally adsorbed on the paper discharging side of the blade 210, and by close attachment of the paper pushing groove 310 to the paper discharging side through the paper pushing edge, the paper can be pushed out from the blade 210, thus reducing the material used for the paper pushing frame 300.

Further, the paper distributor further comprises a plurality of paper pressing shaft assemblies 500 and a roll paper mounting and placing assembly mounted on the machine shell 400, the plurality of paper pressing shaft assemblies 500 are annularly arranged on a peripheral side of the cutting roller body 100 at intervals, the roll paper mounting and placing assembly comprises two sleeving columns 600, and the two sleeving columns 600 are oppositely arranged on the two side plate bases 410. The roll paper mounting and placing assembly is mainly used for placing roll paper, two ends of the roll paper are mounted on the two sleeving columns 600, a paper head of the paper is wound around the plurality of paper pressing shaft assemblies 500 in sequence, the paper pressing shaft assemblies 500 press the paper on the peripheral wall of the cutting roller body 100, and the paper is driven to be conveyed forward by a rotating friction.

The paper pressing shaft assembly 500 has many structural forms, such as the structure including a smooth shaft and a shaft sleeve sleeved on the smooth shaft, and the structure of a plurality of shaft collars, which plays a role of pressing and guiding the paper. In this embodiment, a plurality of rubber sleeves 130 are sleeved on a periphery of the cutting roller body 100, and the plurality of rubber sleeves 130 are arranged on the cutting roller body 100 at intervals in an axial direction. The rubber sleeve 130 can improve the friction with the paper, thus avoiding the paper from slipping during conveying.

Further, the paper distributor further comprises a roll paper residual amount monitoring assembly, the roll paper residual amount monitoring assembly comprises a monitoring swing frame 610 and a monitoring module 620, one end of the monitoring swing frame 610 is rotatably connected with an inner side wall of one of the side plate bases 410, the other end of the monitoring swing frame 610 is connected with a contact pressure block 611, an elastic reset member 612 is arranged between the monitoring swing frame 610 and the side plate base 410, the elastic reset member 612 is used for swinging the monitoring swing frame 610 until the contact pressure block 611 approaches a peripheral wall of the sleeving column 600, and one end of the monitoring swing frame 610 connected with the side plate base 410 is connected with the monitoring module 620 through a transmission rod member 630. When in use, the roll paper is sleeved between two sleeving columns 600, under an action of the elastic reset member 612, the monitoring swing frame 610 drives the contact pressure block 611 to press on a periphery of the roll paper, and an outer diameter of the roll paper is gradually reduced. When a residual usage amount of the roll paper reaches a set value, the elastic reset member 612 drives the monitoring swing frame 610 to swing, and the monitoring swing frame 610 drives the transmission rod member 630 to move. At the moment, the transmission rod member 630 moves relative to the monitoring module 620, and the monitoring module 620 will send out a warning signal to warn that the roll paper is used up or needs to be replaced soon. The transmission rod member 630) may have various structures. Specifically, the transmission rod member 630 may have a lever structure, a middle portion of the transmission rod member 630 is rotatably connected with the side plate base 410, one end of the transmission rod member 630 is connected with the monitoring swing frame 610, and the other end of the transmission rod member 630 abuts against the monitoring module 620. When the monitoring swing frame 610 swings, the other end of the transmission rod member 630 presses the monitoring module 620. The monitoring module 620 may be provided with a push switch, and the monitoring module 620 may be provided with a speaker or a warning light to achieve a warning effect.

The elastic reset member 612 is a torsion spring.

Moreover, in an embodiment, the paper distributor further comprises a rotary driving assembly mounted on one of the side plate bases 410, the rotary driving assembly comprises a rotary driving unit 700, a gear transmission mechanism 710 and a first gear 720 coaxially connected with the cutting roller body 100, and the rotary driving unit 700 is engaged with the first gear 720 through the gear transmission mechanism 710 in a transmission mode. The rotary driving unit 700 drives the gear transmission mechanism 710 to move, and the gear transmission mechanism 710 drives the first gear 720 to rotate, so as to realize the automatic rotation of the cutting roller body 100, wherein the rotary driving unit 700 is a servo motor.

In addition, the paper distributor further comprises a manual driving assembly mounted on one of the side plate bases 410, the manual driving assembly comprises a swing rod member 800 rotatably mounted on the side plate base 410 and a first tension spring 810 connected between the side plate base 410 and the swing rod member 800, one end of the swing rod member 800 is connected with a sector gear 820, the sector gear 820 is engaged with the first gear 720, and the first gear 720 is connected with the cutting roller body 100 through a one-way bearing. A user may drive the sector gear 820 to rotate by swinging the swing rod member 800, and under the condition that the sector gear 820 is engaged with the first gear 720, the cutting roller body 100 is driven to rotate, and the first tension spring 810 may pull the swing rod member 800 to reset. The first gear 720 is connected with the cutting roller body 100 through the one-way bearing, so the sector gear 820 will not drive the cutting roller body 100 to rotate when rotating back to reset.

In an embodiment, the paper distributor further comprises a reset locking assembly, the reset locking assembly comprises a ratchet wheel 900 coaxially connected with the cutting roller body 100, a brake block 910 and a second tension spring 920 mounted on one of the side plate bases 410, the second tension spring 920 is connected between the side plate base 410 and the ratchet wheel 900, and the brake block 910 is engaged with the ratchet wheel 900 in an elastic stopping mode. In this embodiment, the reset locking assembly is provided to lock and position the cutting roller body 100 and prevent the cutting roller body from rotating in an opposite direction. During the rotation of the cutting roller body 100, the ratchet wheel 900 pushes the brake block 910 away, arrangement positions of the brake block 910 and the ratchet wheel 900 are also determined according to a rotation direction of the cutting roller body 100 during paper cutting. After the cutting roller body 100 stops cutting paper and rotating, the second tension spring 920 pulls the ratchet wheel 900, and at the moment, the brake block 910 is engaged with the ratchet wheel 900 in a stopping mode.

In an embodiment, the cutting roller body 100 is further coaxially and fixedly connected with a rotating knob, and the cutting roller body 100 may be directly rotated by rotating the knob.

The above describes the preferred embodiments of the disclosure in detail, but the disclosure is not limited to the embodiments. Those of ordinary skills in the art may further make various equivalent modifications or substitutions without violating the gist of the disclosure, and these equivalent modifications or substitutions are all included in the scope defined by the claims of the present application.

1. A cutting roller, comprising:
a cutting roller body, wherein a knife groove is concavely formed in a peripheral wall of the cutting roller body which extends across the cutting roller body in an axial direction; and
a cutting knife assembly, comprising a knife frame and a paper pushing frame arranged in the knife groove, and a blade mounted on the knife frame, wherein the blade extends along the knife groove, the paper pushing frame is provided with a paper pushing groove, and the blade is slidably sleeved and matched with the paper pushing groove in a transmission mode;
wherein the paper pushing frame is slidably connected with the knife groove, the paper pushing frame is slidably arranged relative to the cutting roller body in a circumferential direction of the cutting roller body, at least one of two ends of the knife frame extending along the knife groove is provided with a linkage component, the linkage component is provided with a swing connecting portion arranged on an inner side and a driven connecting portion arranged on an outer side, the swing connecting portion is rotatably connected with an end face of the cutting roller body, the knife frame is configured to swing back and forth to drive the blade to extend out of and into the knife groove, and the paper pushing frame is configured to follow the blade to move back and forth;
wherein when the blade extends out of the knife groove, the paper pushing frame follows the blade to move, and the blade extends out of the knife groove from the paper pushing groove; and
wherein when the blade extends into the knife groove, the paper pushing frame follows the blade to move, and the blade extends into the knife groove from the paper pushing groove.

2. The cutting roller according to claim 1, wherein sliding guide frames are fixedly arranged on two end sides of an opening of the knife groove, the sliding guide frame is provided with an arc-shaped guide groove, and two ends of the paper pushing frame are slidably connected with the arc-shaped guide grooves.

3. The cutting roller according to claim 1, wherein two sides of the blade are divided into a paper feeding side and a paper discharging side, and the paper pushing groove is provided with a paper pushing edge closely attached to the paper discharging side.

4. The cutting roller according to claim 1, wherein a plurality of rubber sleeves are sleeved on a periphery of the cutting roller body, and the plurality of rubber sleeves are arranged on the cutting roller body at intervals in an axial direction.

5. A paper distributor, comprising the cutting roller according claim 1, and a machine shell, wherein the machine shell is provided with two side plate bases arranged oppositely, two ends of the cutting roller body are rotatably connected with the two side plate bases respectively, an inner side face of at least one of the two side plate bases is provided with a cam groove, and the driven connecting portion is slidably connected and matched with the cam groove.

6. The paper distributor according to claim 5, wherein the paper distributor further comprises a plurality of paper pressing shaft assemblies and a roll paper mounting and placing assembly mounted on the machine shell, the plurality of paper pressing shaft assemblies are annularly arranged on a peripheral side of the cutting roller body at intervals, the roll paper mounting and placing assembly comprises two sleeving columns, and the two sleeving columns are oppositely arranged on the two side plate bases.

7. The paper distributor according to claim 6, wherein the paper distributor further comprises a roll paper residual amount monitoring assembly, the roll paper residual amount monitoring assembly comprises a monitoring swing frame and a monitoring module, one end of the monitoring swing frame is rotatably connected with an inner side wall of one of the side plate bases, the other end of the monitoring swing frame is connected with a contact pressure block, an elastic reset member is arranged between the monitoring swing frame and the side plate base, the elastic reset member is used for swinging the monitoring swing frame until the contact pressure block approaches a peripheral wall of the sleeving column, and one end of the monitoring swing frame connected with the side plate base is connected with the monitoring module through a transmission rod member.

8. The paper distributor according to claim 5, wherein the paper distributor further comprises a rotary driving assembly mounted on one of the side plate bases, the rotary driving assembly comprises a rotary driving unit, a gear transmission mechanism and a first gear coaxially connected with the cutting roller body, and the rotary driving unit is engaged with the first gear through the gear transmission mechanism in a transmission mode.

9. The paper distributor according to claim 5, wherein the cutting roller body is coaxially connected with a first gear, the paper distributor further comprises a manual driving assembly mounted on one of the side plate bases, the manual driving assembly comprises a swing rod member rotatably mounted on the side plate base and a first tension spring connected between the side plate base and the swing rod member, one end of the swing rod member is connected with a sector gear, the sector gear is engaged with the first gear, and the first gear is connected with the cutting roller body through a one-way bearing.

10. The paper distributor according to claim 9, wherein the paper distributor further comprises a reset locking assembly, the reset locking assembly comprises a ratchet wheel coaxially connected with the cutting roller body, a brake block and a second tension spring mounted on one of the side plate bases, the second tension spring is connected between the side plate base and the ratchet wheel, and the brake block is engaged with the ratchet wheel in an elastic stopping mode.
